(19) United States
(12) Patent Application Publication
(10) Pub. No.: US 2012/0034828 A1
(43) Pub. Date: Feb. 9, 2012

(54) OUTBOARD MOTORS AND METHODS OF MAKING THE SAME

(76) Inventor: William White, Kalama, WA (US)

(21) Appl. No.: 13/277,454

(22) Filed: Oct. 20, 2011

(51) Int. Cl. B63H 20/14; B23P 11/00; B63H 20/02

(52) U.S. Cl. 440/53; 29/428

(57) ABSTRACT

Lightweight and versatile outboard motors and methods for manufacturing the same from existing motorized lawn implements and lawn implement parts. The outboards consisting essentially of a motor for driving a propeller, an elongate housing creating the body of the outboard, a drive shaft disposed within the elongate housing, and a propeller. The methods involving attaching the motor to the elongate housing and the drive shaft and mounting the propeller to a second end of the elongate housing and drive shaft.

### BACKGROUND

The present disclosure relates generally to outboard motors (“outboards”) and methods for their manufacture. In particular, outboard motors adapted from existing motorized lawn-care implements and lawn care implement parts are described.

Known outboard motors are not entirely satisfactory for the range of applications in which they are employed. For example, existing outboards are cumbersome. The weight of a typical outboard makes transport, attachment, detachment, and general use difficult. Standard outboards have a heavy motor and a cast metal casing that add significant weight to the boat and affect the boat's handling. This is especially true where the outboard is being used with a small vessel.

The smallest vessels do not typically have the load bearing capacity for an outboard motor. A flat back canoe for example cannot easily support a typical outboard. A canoe relies on a balanced and partially submerged hull for steering and handling. A motor that is too heavy lifts the front of the vessel from the water and diminishes handling and performance. Even conventional trolling outboards and compact design outboards are too heavy. The electric versions require a deep cycle marine battery that, in addition to its substantial weight, requires charging.

Because compact electric motors require charging, a user is also limited in the distance he may travel on a given charge. A motor that relies solely on a charged battery is inefficient to accomplish consistent, reliable travel of various distances.

Another limitation created by the weight of existing outboards is the difficulty involved in transporting, attaching, and detaching the motor. Often, a user must remove and re-install the motor for storage, repair, cleaning, or transfer between vessels. Likewise, after removal the motor must be transported. This is not easily accomplished with a standard weight outboard. A lighter motor solves the problems associated with transporting a heavy motor and allows a user to make full use of the outboard without aid.

In addition to weight limitations, typical outboards are expensive. An outboard adapted from existing inexpensive and readily-available parts would keep sourcing and manufacturing costs low. Additionally, a company currently producing motorized lawn implements and parts would have no need for re-tooling or reorganizing product manufacturing and design if it were to simply adapt existing products into outboards. An outboard motor created from substantially the same materials as an existing lawn implement would minimize overhead costs while increasing a company's ability to offer a new but related product. This would result in a lower consumer price-point for new outboards, and better price and availability for replacement parts.

Thus, there exists a need for outboard motors that improve upon and advance the design of known outboards. Examples of new and useful outboards relevant to the needs existing in the field are discussed below.

### SUMMARY

The present disclosure is directed to outboard motors and methods of manufacture for outboard motors from existing motorized lawn implements and motorized lawn implement parts. Existing lawn implements and components are modified and adapted to create outboard motors. The conventional lawn-care implement components include a motor attached to an elongate housing that forms the body of the outboard. A flexible drive shaft within the housing couples with the motor on one end and engages a propeller on the opposite end creating an outboard motor.

### BRIEF DESCRIPTION OF THE DRAWINGS

FIG. 1 is a side elevation view of a first example of an outboard motor

FIG. 2 is a perspective view of the outboard motor shown in FIG. 1 depicting attachment to a small passenger boat

FIG. 3 is a perspective view of first example of a weed trimmer from which the outboard motor of FIG. 1 could be manufactured

FIG. 4 is a flowchart describing a method for manufacturing an outboard motor according to a preferred embodiment of the present invention

FIG. 5 is a flowchart describing a method for manufacturing an outboard motor according to a preferred embodiment of the present invention

FIG. 6 is a flowchart describing a method for manufacturing an outboard motor according to a preferred embodiment of the present invention

FIG. 7 is a flowchart describing a method for manufacturing an outboard motor according to a preferred embodiment of the present invention

### DETAILED DESCRIPTION

The disclosed outboard motors and methods for their manufacture will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various outboards are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given sample will be described in that particular example. The reader should understand that a given feature need not be the same or similar to the specific portrayal of a related feature in any given figure or example.

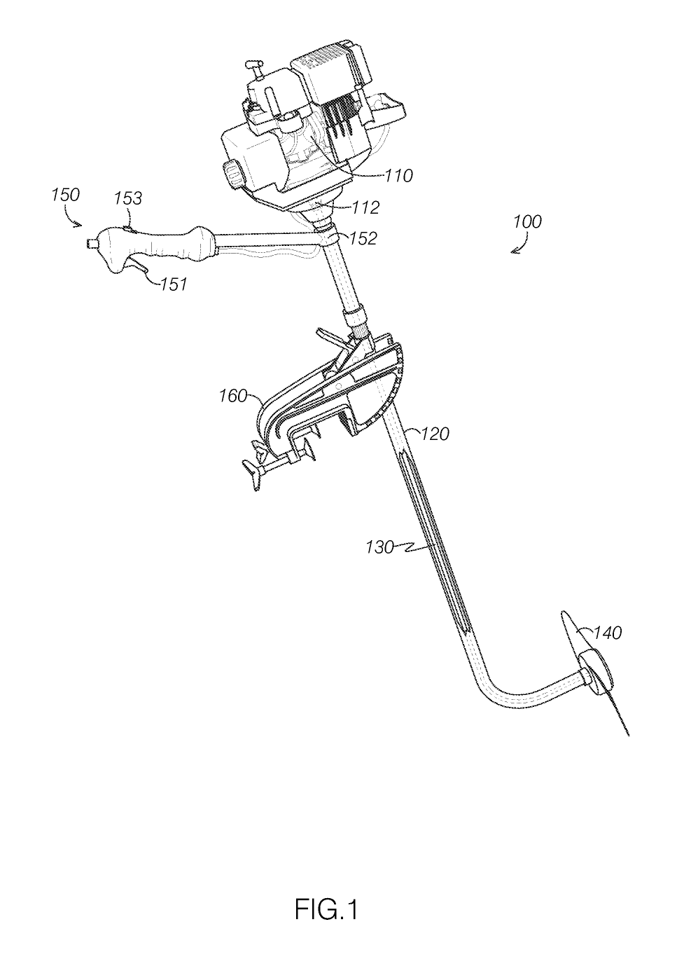

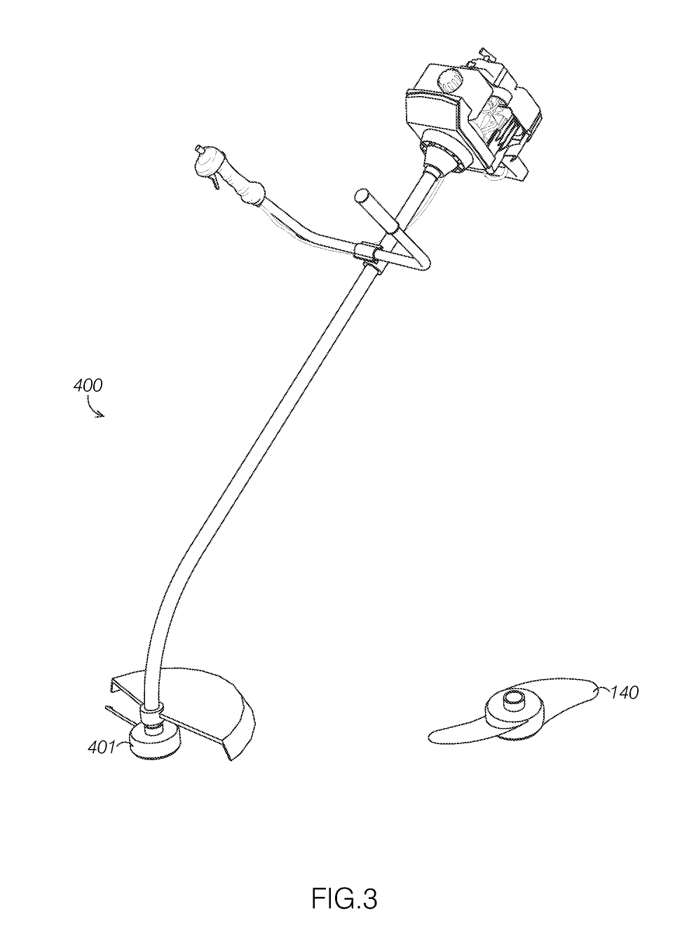

The outboard motors and methods for manufacture described below include outboards manufactured largely from existing motorized lawn care implements and lawn care implement parts. With reference to FIGS. 1-3, a first example of an outboard motor, outboard 100, will now be described. By way of example only, FIG. 3 shows a typical motorized weed trimmer 400 from which outboard 100 might be manufactured. Weed trimmer 400 is merely one implement that might be used, in whole or in part, to construct outboard 100. In yet many other examples outboards may be constructed from an edger, a brush cutter, a tiller, any motorized lawn implement, or their individual components thereto.

With reference to FIG. 1, outboard 100 includes a motor 110, an output shaft 112, a flexible drive shaft 130, an elongate housing 120, a propeller 140, a steering control arm 150, and a transom mounting bracket 160. Outboard 100 functions to provide a watercraft user (“user”) with a lightweight, inexpensive outboard motor that is fuel efficient and low maintenance. Outboard 100 provides propulsion for am type of watercraft. In particular, outboard 100 is suited to be the sole drive motor for smaller watercraft like canoes, rafts, kayaks, jon boats, and dinghies.

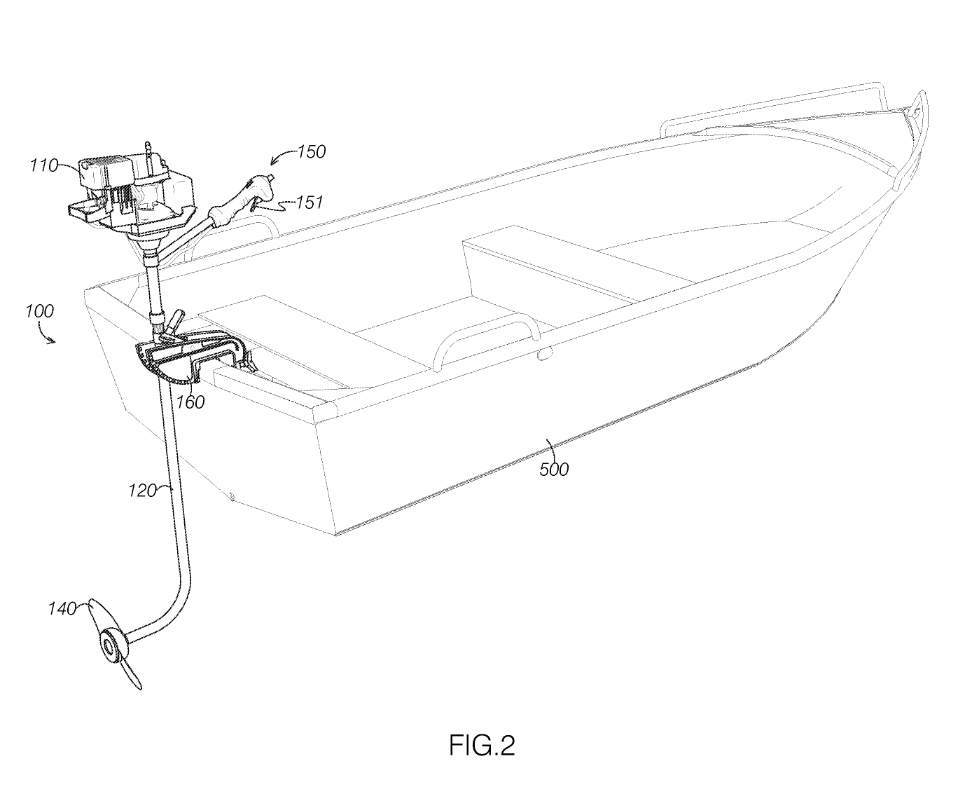

Additionally outboard 100 can provide auxiliary propulsion or trolling propulsion for larger crafts like sailboats, mid-size fishing boats, and passenger craft. By way of example only, FIG. 2 shows outboard 100 attached to a small passenger boat. In this example outboard 100 is situated to provide the sole source of propulsion. In yet another example, outboard 100 could be used as secondary propulsion or trolling propulsion by being mounted to the transom next to the primary drive motor.

The drive power for outboard 100 in FIGS. 1 and 2 comes from motor 110. In the instant embodiment motor 110 represents a standard weed trimmer motor as known in the art. Motor 110 is a two-stroke combustion engine using mixed fuel. In another embodiment the motor is a four-stroke combustion engine. In yet other embodiments the motor is a two or four stroke combustion engine utilizing regular fuel or mixed. An embodiment utilizing a diesel motor is also disclosed.

While some specific embodiments have been listed various further embodiments do not limit the type of motor that can be used for the disclosed outboard and method for manufacture. Any motor commonly known or used in the art sufficient to provide forward propulsion for a given watercraft is contemplated.

As shown in FIG. 1, motor 110 includes output shaft 112. Output shaft 112 is attached at a first end to motor 110 and at a second end connects to flexible drive shaft 130. In the present example, the second end of output shaft 112 receives a first end of flexible drive shaft 130. Output shaft 112 and flexible drive shaft 130 are coupled together with the first end of flexible drive shaft 130 keyed to fit within the second end of output shaft 112.

In other embodiments the output shaft and flexible drive shaft are coupled together with coupling methods known in the art. In one example the coupling is accomplished with a threaded first end of the flexible drive shaft and a threaded second end of the output shaft such that both ends may be threaded together. In any embodiment the second end of the output shaft is drivingly connected to the first end of the flexible drive shaft transferring the forward drive of the motor to the flexible drive shaft.

Turning our attention to flexible drive shaft 130 in FIG. 1, we see that the first end of flexible drive shaft 130 drivingly connected to output shaft 112 and a second end drivingly connected to propeller 140. In this embodiment, flexible drive shaft 130 is a standard weed trimmer drive shaft. In yet other embodiments the flexible drive shaft consists of any shaft known in the art including those from a brush cutter, an edger, or any motorized lawn implement. The coupling of flexible drive shaft 130 to output shaft 112 and the disposal of said shafts within elongate housing 120 resemble a common configuration as found in existing motorized lawn implements.

Flexible drive shaft 130 has a length that is easily modifiable based upon a given transom height. Since outboard 100 is intended to fit a range of watercraft, the overall length of outboard 100 is preferably modifiable. Flexible drive shaft 130 can be cut to a prescribed length and re-coupled with output shaft 112 and propeller 140.

FIG. 1 shows that flexible drive shaft 130 is disposed within elongate housing 120. Elongate housing 120 is a hollow housing that provides the rigid structure to which most of the individual components of outboard 100 attach. Elongate housing 120 is mounted at a first end to motor 110 so that output shaft 112 and flexible drive shaft 130 are seated within the first end of said housing. A second end of elongate housing 120 is attached to propeller 140 so that the coupling between flexible drive shaft 130 and propeller 140 is seated within the second end of said housing. Both the first and second end of elongate housing 120 are mounted to output shaft 112 and propeller 140 respectively, so that said output shaft, said propeller, and flexible drive shaft 130 are able to spin freely.

Turning our attention specifically to propeller 140 we find that said propeller is drivingly coupled to flexible drive shaft 130 and mounted to the second end of elongate housing 120 such that said flexible drive shaft and said propeller are able to spin freely. In the instant example propeller 140 is a standard two-blade propeller. In another embodiment the propeller is a three-blade model. In yet other embodiments any currently known or later developed propeller sufficient to provide forward propulsion is contemplated.

Shifting our attention now to steering control arm 150 in FIG. 1 we see that said steering control arm includes an attachment collar 152, a throttle lever 151, and a motor kill switch 153. Steering control arm 150 adjustably mounts to elongate housing 120 via attachment collar 152. In the present example attachment collar 152 is slidingly mounted to elongate housing 120 with the inside diameter of the collar nesting with the outside diameter of the housing. In this and other embodiments a set screw is used to hold the nested portions of the attachment collar and the elongate housing in place. In yet other examples a quick release compression fitting is used.

Attachment collar 152 is adjustable along the length of elongate housing 120 and in the instant embodiment is set to face towards the interior of a given watercraft. FIG. 2, for example, depicts outboard 100 mounted on the transom of a small passenger boat. Steering control arm 150 is shown facing the interior of the boat where a user can easily interface for steering. In the present embodiment steering control arm 150 is used to control the drive direction, speed, and function of outboard 100.

The drive direction or steering of outboard 100 is regulated by steering control arm 150. A user interfacing with steering control arm 150 can move said arm laterally to steer the boat right or left. A user moving the arm toward the right side of the boat (starboard) will steer the boat left. A user moving the arm toward the left side of the boat (port) will steer the boat right.

The speed of outboard 100 is regulated by the throttle lever 151. Throttle lever 151 is exemplary of throttles commonly known in the art and regulates the fuel/air mixture entering motor 110. In the present embodiment, throttle lever 151 is a pull lever mounted towards the terminal end of steering control arm 150. The more that a given user pulls the throttle lever the faster the motor spins. In another embodiment the throttle lever is a twisting throttle as known in the art. In yet another example, the throttle lever is a push lever throttle as known in the art.

In the instant example, motor kill switch 153 is mounted to steering control arm 150 at the terminal end near throttle lever 151. Motor kill switch 153 is a standard kill switch as commonly known in the art. Motor kill switch 153 serves to turn motor function on or off.

Turning now to transom mounting bracket 160 we see in FIG. 1 that transom mounting bracket 160 is slidingly attached to elongate housing 120. Transom mounting bracket 160 is a standard transom mount as known in the art. In the present embodiment transom mounting bracket 160 is adapted to slidingly receive elongate housing 120. Transom mounting bracket 160 is adjustable along the length of said housing. In every embodiment of the present invention any transom mounting bracket capable of securing outboard 100 to the transom of a given watercraft is contemplated.

Having described a number of examples for outboard motors we now turn our attention to the methods for their manufacture. The disclosed methods include examples for manufacturing outboards by adapting existing, pre-built motorized lawn implements and also for manufacturing outboards from motorized lawn implement parts.

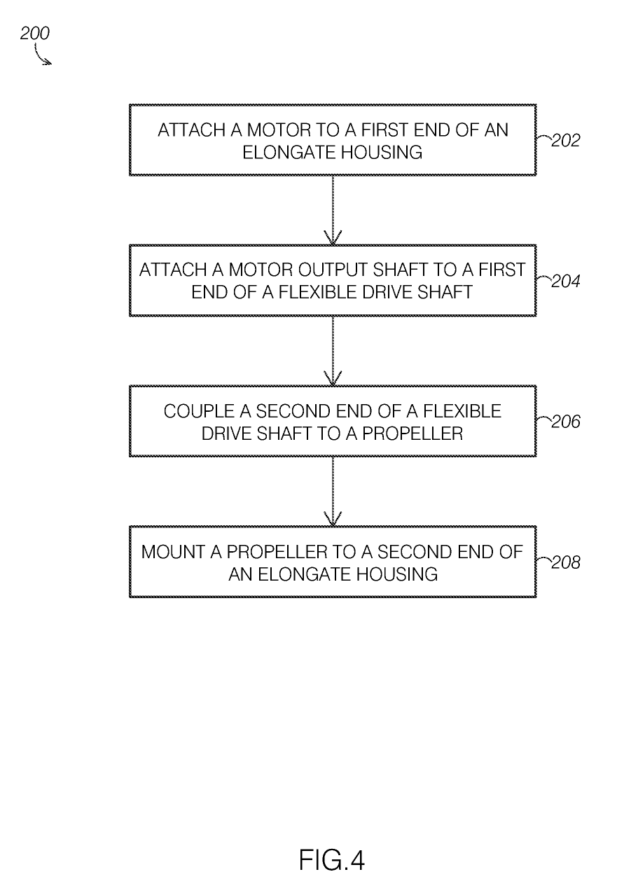

With reference to FIG. 4 a method 200 is described. Method 200 is one example of a method whereby an outboard motor, similar to outboard 100 above, is built from individual motorized lawn implement parts. Method 200 initiates at step 202 by attaching a lawn implement motor, similar to motor 110 disclosed above, to a first end of a lawn implement elongate housing. The elongate housing, similar to elongate housing 120 above, serves to provide a structure to which the outboard components attach.

Next, at step 204, a motor output shaft, similar to output shaft 112 above, extending from within the motor is attached to a first end of a flexible drive shaft, similar to flexible drive shaft 130 above, said flexible drive shaft being disposed within the elongate housing. The attachment of the motor output shaft to the flexible drive shaft is accomplished such that the drive from the motor is transferred into the flexible drive shaft. One example of coupling the output shaft and the flexible drive shaft is discussed above in connection with coupling output shaft 112 to flexible drive shaft 130. The attachment of the motor to the elongate housing, in which the flexible drive shaft is disposed, is accomplished such that said flexible drive shaft and said output shaft are drivingly connected and spin freely within the housing.

A second end of the flexible drive shaft is coupled to a propeller, similar to propeller 140 above, at step 206 of method 200. One example of coupling the flexible drive shaft and the propeller is discussed above in connection with coupling flexible drive shaft 130 with propeller 140. The coupling is accomplished such that the drive output of the motor is transferred to the propeller via the flexible drive shaft.

Finally, at step 208 a second end of the elongate housing is mounted to the propeller. In the instant method, the second end of the elongate housing is mounted to the propeller in a similar manner as disclosed above. The attachment of the elongate housing to the propeller is accomplished such that the flexible drive shaft and the propeller are able to freely spin independent of the elongate housing.

Although method 200 is fully disclosed in method steps 202 through 208 additional optional steps may further include shortening the elongate housing, bending the elongate housing, mounting a steering control arm, and attaching a transom mounting bracket.

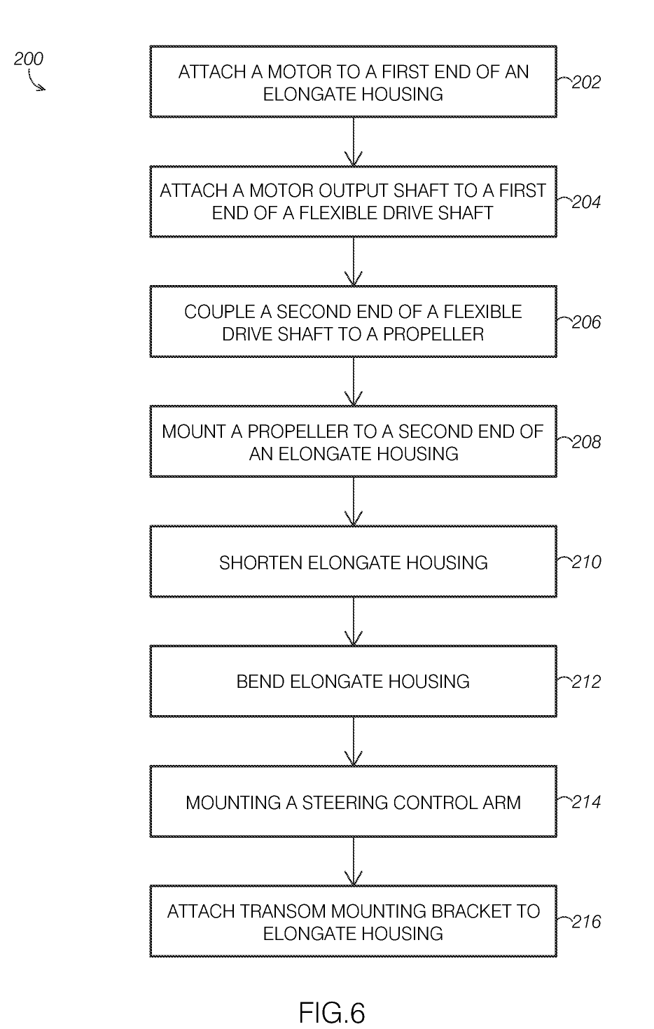

With reference to FIG. 6 optional step 210 introduces shortening the elongate housing. The elongate housing is the structure that determines the overall length of the outboard motor. Because the outboard is meant to be attached to a range of watercraft with varying transom heights and varying distances from the top of the transom to the water, the elongate housing is preferably adaptable within that range.

The elongate housing, as discussed above, may to be shortened to a selected length prior to attachment to the propeller at step 208. Outboard 100 disclosed above, for example, utilizes a full length elongate housing. In another embodiment the elongate housing is shortened to fit a smaller transom height.

Another optional step shown in FIG. 6 is bending the elongate housing to achieve a desired drive angle at step 212. Many standard elongate housing examples are unbent or only slightly bent when used as a lawn implement. When the housing is adapted for use in an outboard motor however, a selectable drive angle is desirable. In order to produce forward propulsion the propeller must enter the water and face away from the transom. Bending the elongate housing at an angle similar to that shown in FIG. 1 increases the ability for the outboard to propel the craft forward.

In the example disclosed above the drive angle is bent to approximately 90 degrees. In another example the elongate housing is bent to a drive angle of more than 90 degrees. In yet other examples the drive angle is less than 90 degrees. After bending the elongate housing, the flexible drive shaft disposed within the elongate housing automatically bends with the housing.

Shifting our attention now to optional step 214 of method 200 in FIG. 6, mounting a steering control arm is described. Steering control arm serves to steer the outboard. The steering control arm adjustably mounts to elongate housing via an attachment collar similar to that shown in sample outboard 100 discussed above. Attachment collar 152 is slidingly mounted to elongate housing 120 with the inside diameter of the collar nesting with the outside diameter of the housing. In this and other embodiments a set screw is used to hold the nested portions of the attachment collar and the elongate housing in place. In yet other examples a quick release compression fitting is used. In the instant embodiment the steering control arm is set to face towards the interior of a given watercraft. FIG. 2 for example depicts outboard 100 mounted on the transom of a small passenger boat. Steering control arm 150 is shown facing the interior of the boat where a user can easily interface for steering.

Turning our attention to attaching a transom mounting bracket at step 216 in FIG. 6. The transom mounting bracket contemplated at step 216 is similar to transom mounting bracket 160 disclosed above. Any transom mounting bracket as known in the art capable of attaching an outboard to the transom of a given watercraft is sufficient for step 216. In the above disclosed embodiment, transom mounting bracket 160 is adapted to slidingly receive elongate housing 120. Transom mounting bracket 160 is adjustable along the length of said housing. Standard transom mounting brackets known in the art are pre-equipped with attachment means ranging from typical set-screw configurations to quick release adjustable clamps.

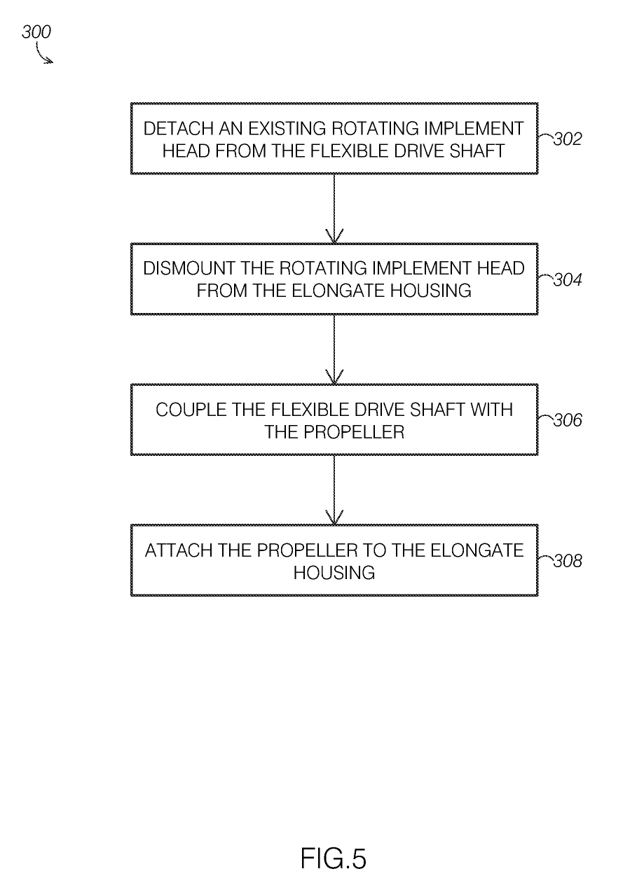

With reference to FIG. 5, a method 300 for manufacturing an outboard motor from an existing motorized lawn implement is described. By way of example only, method 300 will be described using a typical motorized weed trimmer 400 from FIG. 3. Method 300 is not limited for use to weed trimmer 400 but is useable with any motorized lawn implement. Specific implements include an edger, a brush cutter, or a tiller as commonly known in the art.

Method 300 begins at step 302 by detaching an existing rotating implement head 401 from a flexible drive shaft. In the present example, rotating implement head 401 is a weed trimming head. Rotating implement head 401 and equivalent structures of other embodiments are detached from the flexible drive shaft and dismounted from a second end of an elongate housing to provide space for installing a propeller.

Rotating implement head 401 is dismounted from the elongate housing at step 304. The detaching and dismounting of the existing rotating implement head 401 and equivalent structures in other embodiments is accomplished such that the flexible drive shaft and the elongate housing is prepared to receive the propeller. Existing lawn care implements are designed to have a detachable rotating implement head. The process for removal varies according to the type of implement head. Most implement heads are attached via threaded couplings, set screws, or compression clamps as disclosed above. These heads can simply be unthreaded, unscrewed, or unclamped for removal.

Next, the flexible drive shaft is coupled with the propeller at step 306. Propeller coupling is disclosed at length above and requires simply that the flexible drive shaft be drivingly connected to the propeller. The propeller is attached to the elongate housing at step 308. The coupling and attachment of the flexible drive shaft and the elongate housing to the propeller are accomplished such that the flexible drive shaft and the propeller are drivingly connected and the propeller is able to spin freely.

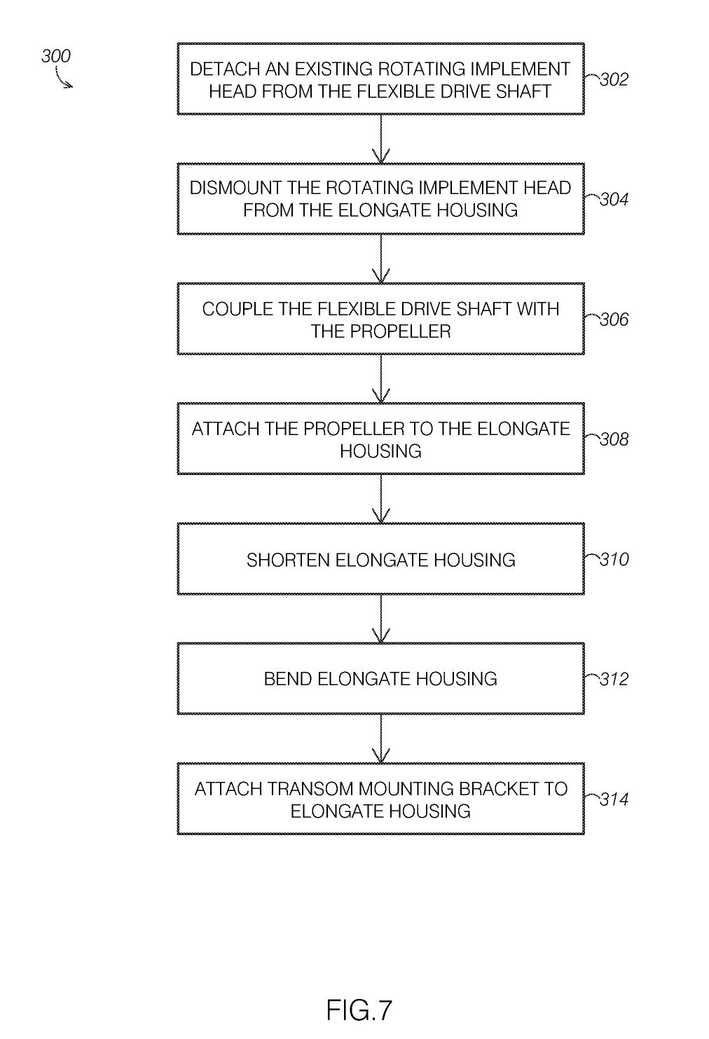

Although method 300 is accomplished with steps 302 through 308, there exist additional optional steps that may be added in the manufacture of outboard motors from existing motorized lawn implements. With reference to FIG. 7, steps 310 to 314 describe shortening the elongate housing at step 310, bending the elongate housing at step 312, and attaching a transom mounting bracket to the elongate housing at step 314. Analogous steps for shortening, bending, and attaching a transom mounting bracket to the elongate housing are described at length in method 200 above.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and sub-combinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant reserves the right to submit claims directed to combinations and sub-combinations of the disclosed inventions that are believed to be novel and non-obvious. Inventions embodied in other combinations and sub-combinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for assembling an outboard motor from conventional lawn-care implement components and a propeller, the conventional lawn-care implement components including a motor having an output shaft, an elongate housing, and a flexible drive shaft disposed within the housing, the method comprising:
attaching the motor to a first end of the elongate housing;
attaching the output shaft to a first end of the flexible drive shaft;
coupling a second end of the flexible drive shaft opposite the first end of the drive shaft to the propeller; and
mounting the propeller to a second end of the elongate housing opposite the first end of the elongate housing.

2. The method of claim 1, wherein the conventional lawn-care implement components collectively define a weed-trimmer.

3. The method of claim 1, further comprising mounting a steering control arm to the elongate housing.

4. The method of claim 1, further comprising shortening the elongate housing to fit a given transom.

5. The method of claim 1, further comprising bending the elongate housing between the motor and the propeller to achieve a desired drive angle.

6. The method of claim 1, further comprising attaching a transom mooting bracket to the elongate housing.

7. A method for constructing an outboard motor from a conventional lawn-care implement and a propeller, the conventional lawn-care implement including a motor having an output shaft, an elongate housing, a flexible drive shaft disposed within the housing, a steering control arm, and a rotating implement head, the method comprising:
detaching the rotating implement head from the flexible drive shaft;
dismounting the rotating implement head from the elongate housing;
coupling the flexible drive shaft with the propeller; and
attaching the propeller to the elongate housing.

8. The method of claim 7, further comprising shortening the elongate housing to fit a given transom.

9. The method of claim wherein the conventional lawn-care implement is a weed-trimmer.

10. The method of claim 7, further comprising bending the elongate housing between the motor and propeller to achieve a desired drive angle.

11. The method of claim 7, further comprising attaching a transom mounting bracket to the elongate housing.

12. An outboard motor comprising:
an elongate housing defining a first end and a second end opposite the first end;
a motor mounted to the first end of the elongate housing, the motor including:
an output shaft; and
a steering control arm operably connected to the elongate housing;
a flexible drive shaft disposed within the elongate housing, the flexible drive shaft defining a first end drivingly coupled to the output shaft and a second end opposite the first end; and
a propeller drivingly coupled to the second end of the flexible drive shaft and mounted to the second end of the elongate housing.

13. The outboard motor of claim 12, wherein the steering arm includes a throttle lever and a motor kill-switch.

14. The outboard motor of claim 12, wherein the elongate housing is bent between the first end and the second end of the elongate housing.

15. The outboard motor of claim 12, wherein one or more of the elongate housing, the motor, and the flexible drive shaft define a component of a conventional lawn-care implement.

16. The outboard motor of claim 12, wherein the elongate housing, the motor, and the flexible drive shaft each define a component of a conventional lawn-care implement.

17. The outboard motor of claim 16, wherein the conventional lawn-care implement is a weed trimmer.

18. The outboard motor of claim 12, wherein the motor is a diesel motor.

19. The outboard motor of claim 12 further comprising a transom mounting bracket affixed to the elongate housing.

20. The outboard motor of claim 19, wherein the transom mounting bracket is configured to be adjustably secured along the length of the elongate housing.
